(19) United States
(12) Patent Application Publication
(10) Pub. No.: US 2004/0136487 A1
(43) Pub. Date: Jul. 15, 2004

(54) Digital reactor protection system for preventing common-mode failures

(76) Inventors: Hyun Kook Shin, Daejeon-city (KR); Sang Gu Nam, Daejeon-city (KR); Se Do Sohn, Daejeon-city (KR); Hoon Seon Chang, Daejeon-city (KR); Hung Bae Kim, Daejeon-city (KR); Jai Bok Han, Daejeon-city (KR)

Correspondence Address: NIXON & VANDERHYE, PC, 1100 N GLEBE ROAD, 8TH FLOOR, ARLINGTON, VA, 22201-4714, US

(21) Appl. No.: 10/476,794

(22) PCT Filed: May 15, 2001
(86) PCT No.: PCT/KR01/00786

(30) Foreign Application Priority Data
May 7, 2001 (KR) 2001/24619

(51) Int. Cl. G21C 17/00

(52) U.S. Cl. 376/259

(57) ABSTRACT

Disclosed is a digital reactor protction system capable of self-excluding a software common mode failure. The system comprises four channels, each channel includes two bistable processors, two local coincidence logic processors, two system interface processors, two initiation logics, two reactor trips, two engineered safety features actuation systems, two maintenance and test panels, and two operator modules; wherein one bistable processor and local coincidence processor provided in each channel include an A-type CPU and B-type operating system, respectively, and the other bistable processor and local coincidence processor provided in each channel includes a C-type CPU and D-type operating system, respectively; and wherein the A and C-type CPUs and the B and D-type operating systems are different form each other, respectively, and if a trip condition is produced at the 2of4 (2 out of 4) bistable processor, the local coincidence logic processor transfers a trip signal to the initiation logic to operate the reactor trip and a engineered safety features actuation system.

### TECHNICAL FIELD

The present invention relates to a digital reactor protection system, and more particularly to a digital reactor protection system capable of self-excluding a common mode failure using different kinds of CPUs and system architectures having different operating systems, thereby achieving an improvement in reliability and stability in the operation of a reactor to which the system is applied.

### BACKGROUND ART

A reactor protection system is an important safety system, in which when an abnormal condition occurs in a reactor or a power plant, the system quickly drops control rods into the bottom of a reactor core to shut down the operation of the reactor. Such a reactor comprises a monitor, an operator, a logic circuit, and a trip breaker, in order to monitor operations of the plant while evaluating numerous safety-related operation parameters for determining whether or not the operating condition of the power plant is maintained normally or not.

Specifically, if the safety-related operation parameters measured at the reactor, a nuclear steam supply system, a turbine system, or the like are deviated from the normal operating condition, the shut-down of the reactor is accomplished by opening the trip breaker through a reactor trip logic.

A prior reactor protection system comprises an electronic circuit and a relay, which are based on an analog technology developed in the 1960s. Such a reactor protection system has been employed at Kory 2^{nd}, 3^{rd}, and 4^{th} reactors, Youngkwang 1^{st}, 2^{nd}, 3^{rd}, 4^{th}, 5^{th} and 6^{th} reactors, and Wooljin 3^{rd} and 4^{th} reactors. However, recently, the rapid development of computer and digital technology causes the analog equipment to be replaced with digital equipment, and thus it is difficult to find a supplier manufacturing the analog equipment. By employing a digital system in an instrument control system of the nuclear power plant, the problems of securing reserve parts and discontinuing parts production which are contained in the prior analog system can be solved. Also, drifts resulting from worn-out equipment may be reduced. In addition, the time required for maintaining and testing the system may be shortened by embodying a self-diagnosis and an automatic test. Accordingly, active research to enable an incorporation of such a digital system in recently designed reactor protection systems has been made.

One example is disclosed in Korean Patent Laid-open Publication No. 2001-0013442 (WO 1998/56009), in which a processor of multi architecture is multiplexed into multiple channels using a programmable logic controller (PLC), thereby achieving an improvement in reliability. Since the PLC has relatively fewer input/outputs to be processed per processor, it is used for an uncomplicated process control. In particular, it is advantageous in terms of operation and maintenance since simple software is used. However, since current PLC manufacturers use different standards for PLCS, there is a problem in that it is necessary to use a gateway between different kinds of PLCs or there is a limitation on the transmission/reception of data. Therefore, there is a problem in that the PLC control unit has no compatibility between different kinds of processors and output units.

In addition, digital systems have to solve a problem of software common mode failures, so as to achieve an improvement in reliability, even though it is unnecessary to take into consideration those common mode failures in analog systems. This will be described in more detail. In digital systems, desired functions are implemented using software. Since such software is prepared by a programmer, the quality thereof is determined, depending on the ability of the programmer. For this reason, it is impossible to provide standardized software. In particular, there may be a high possibility that when the programmer makes an error or mistake during a preparation of software, the error or mistake is reflected on the software. If such an error or mistake simultaneously occurs in the same components of the system, the entire system then may operate erroneously. In this case, the system operates normally no longer. In other words, even though an increased multiplexing of hardware is implemented to achieve an improvement in reliability, there may be still a problem in that if the same software, for example, the same operating system, is used for the multiplexed hardware, it is then impossible to ensure a desired reliability in association with common mode failures occurring in the same software. Since the above mentioned problem cannot be solved only by the use of multiplexed hardware, it is necessary to design the system, taking common mode failures into consideration.

In order to overcome the above problems, according to the Korean Patent Laid-open Publication No. 2001-0013442, the software common mode failures are not solved in the reactor protection system itself, but the shut-down of the reactor is accomplished by the provision of a so-called “diverse protection system”. Specifically, when the digital protection system is not properly executed by the common mode failure, the shut-down of the reactor is accomplished by the diverse protection system of a separate protection system after a certain time.

However, the prior method requires a separate independent system, thereby complicating the design of the entire system and increasing the cost. In addition, when the existing analog protection system of the nuclear power plant is replaced, there is a problem in that the design modification of other system is required, in addition to the reactor protection system.

### DISCLOSURE OF THE INVENTION

Therefore, an object of the present invention is to solve the problems involved in the prior art and to provide a digital reactor protection system capable of achieving an improvement in reliability and stability by excluding a common mode failure using different kinds of CPUs and a system architecture having different operating systems.

In order to accomplished the above mentioned object, the present invention provides a digital reactor protection system capable of self-excluding a software common mode failure, comprising four channels of the same construction, each channel including two bistable processors, two local coincidence logic processors, two system interface processors, two initiation logics, two reactor trips, two engineered safety feature actuation systems, two maintenance and test panels, and two operator modules, wherein one bistable processor and local coincidence processor provided in each channel include an A-type CPU and B-type operating system, respectively, and the other bistable processor and local coincidence processor provided in each channel include a C-type CPU and D-type operating system, respectively, and wherein the A and C-type CPUs and B and D-type operating systems are different from each other, respectively, and if a trip condition is produced at the 2of4 (2 out of 4) bistable processor, the local coincidence logic processor transfers the trip signal to the initiation logic to operate the reactor trip and an engineered safety features actuation system.

Another object of the present invention is to provide a method for producing software of the safety class employed in a digital power plant protection system, in which a self-verification is accomplished during a process of designing the software.

### BRIEF DESCRIPTION OF THE DRAWINGS

The above objects, other features and advantages of the present invention will become more apparent by describing the preferred embodiment thereof with reference to the accompanying drawings, in which:

FIG. 1 is a schematic block diagram illustrating the construction of the digital reactor protection system according to the present invention, in which common mode failures are self-precluded.

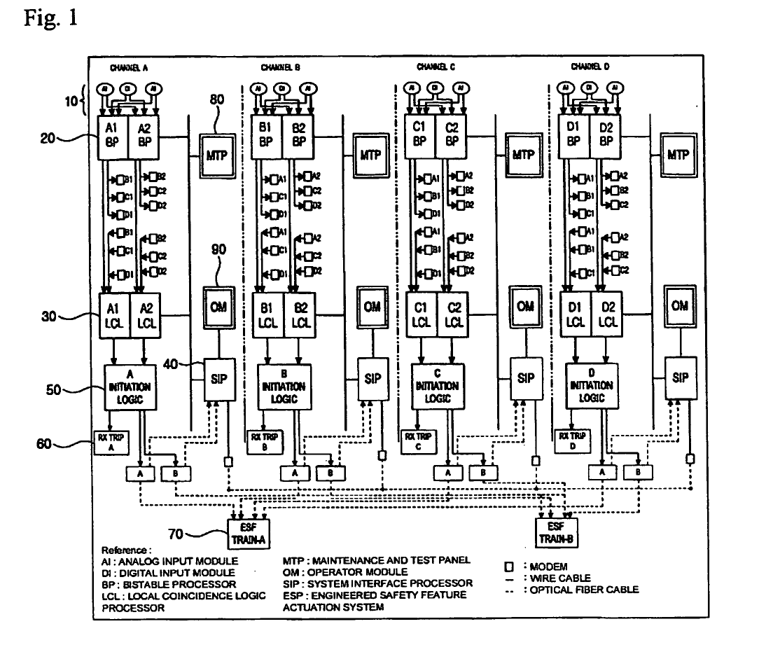

FIG. 2 is a schematic block diagram illustrating the construction of a single channel of the digital reactor protection system according to the present invention, in which common mode failures are self-precluded.

FIG. 3 is a schematic block diagram illustrating the construction of the hardware on the single channel of the digital reactor protection system according to the present invention, in which common mode failures are self-precluded.

FIG. 4 is a schematic view illustrating the concept of a data communication in the multi master system according to the present invention.

FIG. 5 is a schematic view illustrating the interior construction of the bistable software according to the present invention.

FIG. 6 is a schematic view illustrating the interior construction of the coincidence logic software according to the present invention.

FIG. 7 is a flow chart illustrating the process of producing the software to be applied to the digital reactor protection system according to the present invention.

### BEST MODE FOR CARRYING OUT THE INVENTION

Now, a preferred embodiment of the present invention will be described in detail with reference to the annexed drawings.

Referring to the accompanying drawings, the digital reactor protection system comprises basically four channels A, B, C, and D, each channel including a bistable processor (BP) 20, a local coincidence logic processor (LCD) 30, a system interface processor (SIP) 40, an initiation logic 50, a reactor trip 60, an engineered safety features actuation system 70, a maintenance and test panel (MTP) 80, and an operator module 90.

The bistable processor 20 receives a measured value (process parameter value), which is unique for each process, from an input 10 having a process sensor, a signal transmitter, and an analog/digital signal converter, and compares the measured value with a trip set value pre-stored at every process parameter to determine a trip state. The trip state of the bistable processor 20 is transferred to the local coincidence logic processor 30 of the same channel or other channel through a data link.

The local coincidence logic processor 30 includes 2of4 (2 out of 4) coincidence logic which is unique for every trip parameter. If a trip condition is produced at 2of4 bistable processor 20, a trip signal is sent to the initiation logic 50 to operate the reactor trip 60 and the engineered safety features actuation system (ESF) 70. Meanwhile, the 2of4 coincidence logic may be replaced with a 2of3 coincidence logic according to the command of the operator when testing and maintaining the channel.

The initiation logic 50 actuates the reactor trip 60 in response of the determined reactor trip signal, but actuates the engineered safety features actuation system 70, which is necessary to cool the reactor, when the reactor is ruptured.

The system interface processor 40 monitors the operating condition of the system, carries out the automatic test and performs the data transmission with the processors in the channel and other systems.

The maintenance and test panel 80 displays the operating condition of the system, and performs a trip channel bypass and a test.

The operator module (OM) 90 is installed in a main control panel, displays the trip condition and the bypass condition, and helps the operator to perform a reset of a variable set value and an actuating bypass function.

A) Construction of System.

The four channels have the same configuration, and thus the construction and operation of only one channel will fully described hereinafter.

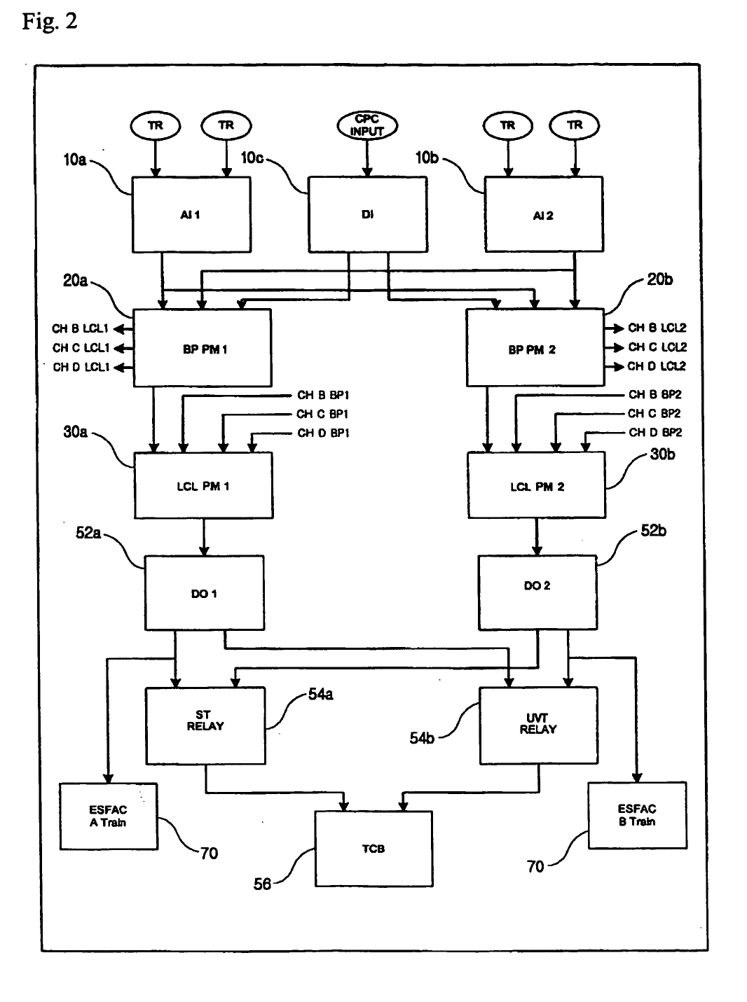

FIG. 2 is a block diagram illustrating the construction of the single channel of the digital reactor protection system according to the present invention, in which a common mode failure occurring due to the software is precluded.

Referring to FIG. 2, each channel of the digital reactor protection system includes two bistable processor modules BP PM1, BP PM2; 20a, 20b, and two local coincidence logic processor modules LCL PM1, LCL PM2; 30a, 30b.

In order to preclude the common mode failure between the processor module, one processor module with an A-type CPU (for example, Intel CPU) built-in is used as the PM1 20a and 30a, while the other processor module with a B-type CPU (for example, Motorola CPU) built-in is used as the PM2 20b and 30b. In order to maintain the variety of the software, each PM1 20a and 20b is built with a C-type operating system (for example, QNX0), while each PM2 20a and 20b is built with a D-type operating system (for example, V×Works). It is noted that the types of A, B, C, and D are merely used as an optional classifying symbol to indicate different kinds of CPUs and operating system.

An analog input signal is inputted to other analog input modules 10a and 10b. The above input will be easily understood with reference to the below table 1. Meanwhile, the reactor trip signal of a core protection calculator system (CPC) is transferred to a digital input (DI) module 10c of the bistable processor 10a and 20b. The digital input module 10c maintains the functional variety together with the analog input modules 10a and 10b of the bistable logic processor.

TABLE 1

| | Input Parameter/ | AI | AI | DI |
|---|---|---|---|---|
| No. | Trip Parameter | Module 1 | Module 2 | Module |
| 1 | Excore Neutron Flux Linear | X | | |
| | Power | | | |
| 2 | Excore Neutron Flux Log | | X | |
| | Power | | | |
| 3 | Pressurizer Pressure Narrow | X | | |
| | Range | | | |
| 4 | Pressurizer Pressure Wide | | X | |
| | Range | | | |
| 5 | Steam Gen. 1 Level Wide | X | | |
| | Range | | | |
| 6 | Steam Gen. 1 Level Narrow | X | | |
| | Range | | | |
| 7 | Steam Gen. 2 Level Wide | | X | |
| | Range | | | |
| 8 | Steam Gen. 1 Level Narrow | | X | |
| | Range | | | |
| 9 | Steam Gen. 1 Pressure | X | | |
| 10 | Steam Gen. 2 Pressure | | X | |
| 11 | Hi Containment Pressure | X | | |
| | Narrow Range | | | |
| 12 | Hi Containment Pressure Wide | | X | |
| | Range | | | |
| 13 | Steam Gen. 1 Delta P RCS | X | | |
| | Flow | | | |
| 14 | Steam Gen. 2 Delta P RCS | | X | |
| | Flow | | | |
| 15 | Refueling Water Tank Level | | X | |
| 16 | Lo Departure from Nucleate | | | X |
| | Boiling Ratio (CPC) | | | |
| 17 | Hi Local Power Density (CPC) | | | X |

As described above, the bistable processor includes a dual structure of processor module, which receives the input signal from a process measuring instrument, a neutron velocity monitoring system, and a core protection operator system through the analog input modules 10a and 10b and the digital input module 10c. The bistable processor processes the comparison logic of the set value related to each input signal, and transfers the results to the local coincidence logic processor.

The bistable processors 20a and 20b built in one channel process have analog and digital input signals in various sequences. Namely, the bistable processor 20a performs the comparison logic in a normal direction from the first trip parameter (in order from the 1^{st} trip parameter to the 17^{th} trip parameter), while the bistable processor 20b performs the comparison logic in a reverse direction (in order from the 17^{th} trip parameter to the 1^{st} trip parameter).

The local coincidence logic processor has a dual architecture of processor module transmitting a trip signal to the initiation circuit, in order to carry out the shut-down of the reactor and the activation of the engineered safety system, when the trip condition occurs in at least two channels among the comparison logic condition of four channels.

The variety of operation sequences carried out by the above bistable processors 20a and 20b is identically applied to the local coincidence logic processors 30a and 30b. In other words, the local coincidence logic processor 30a carries out the local coincidence logic in a normal direction, while the local coincidence logic processor 30b carries out the local coincidence logic in a reverse direction.

Meanwhile, the common mode failure of the digital appliance using the software causes the multiple hardware architecture to be incapable of operating, and particularly the failure mode cannot be anticipated. For example, if the common mode failure occurs in a shut-down direction of the reactor in the processor module with four channels being built with the A-type CPU (for example, manufactured by Intel), the power plant is not influenced by its stability. If the common mode failure occurs while the output of a normal state is maintained, it has a serious effect on the stability of the power plant.

In view of the above matter, a relay contact point between a digital output (DO) 52a of the A-type local coincident logic processor 30a and a digital output 52b of the B-type local coincident logic processor 30b is connected with a hardwired type to form an OR circuit. Accordingly, if the trip signal is produced in the local coincidence logic processors 30a and 30b, the contact point of an under voltage trip relay (UVT Relay) 54b is opened, the contact point of a shunt trip relay (ST Relay) 54a is closed.

If only one of two local coincidence logic processors 30a and 30b outputs the trip signal, the reactor can be shut down, thereby improving the probability of the trip success when an accident occurs.

A trip circuit breaker (TCB) 56 of the final terminal, which shuts down the actuator, is opened when the under voltage trip relay 54b is opened or when the shunt trip relay is closed, and thus, the power supplied to a control rod actuating unit is shut off. The control rod is freely dropped, and the thermal neutron in the reactor is absorbed, so that the actuator shuts down and heat is not generated.

B) Hardware Architecture

In order to achieve the compatibility between different kinds of processors, a single board computer (SBC) is used as a hardware platform.

While using the single board computer, different kinds of processor modules are built in the same rack through a VESA module European (VME) data communication bus, so that they can easily communicate with each other and share the same input/output unit.

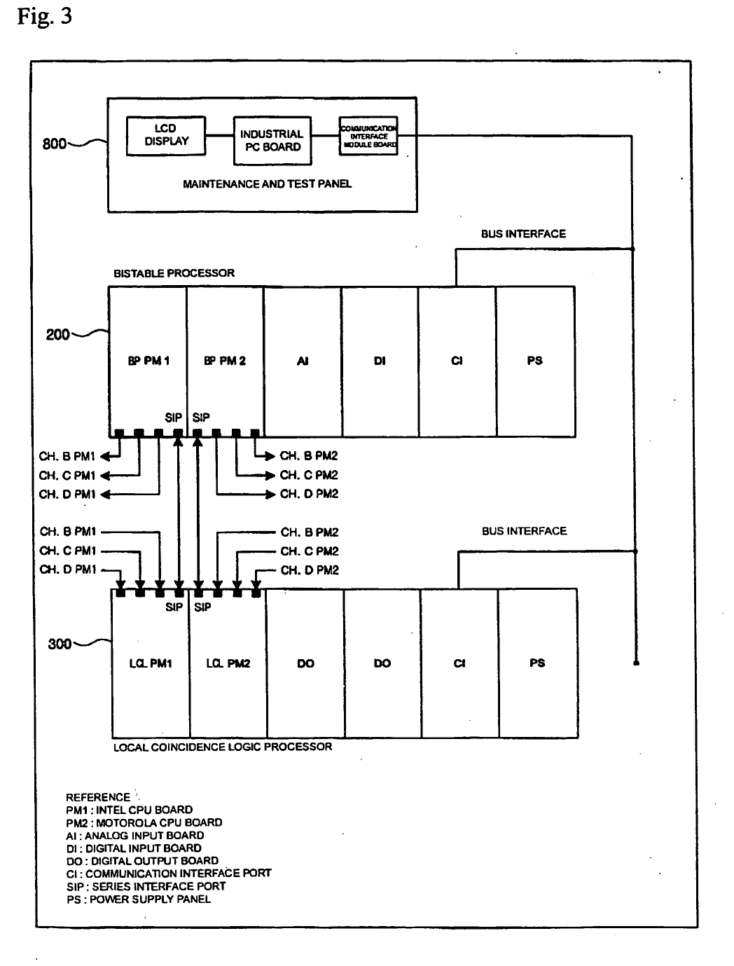

FIG. 3 is a block diagram illustrating the hardware architecture of the single channel of the digital reactor protection system according to the present invention.

The digital reactor protection system comprises a bistable processor rack 200, a local coincidence logic processor rack 300, and a maintenance and test panel 800.

Each processor module BP PM1, BP PM2, LCL PM1, and LCL PM 2 is built with a CPU, SDRAM, and a flash EPROM, and associated application program is stored in the flash EPROM. Each processor module has a desired number of series ports for exchanging a data related to the trip with the corresponding processor module.

A communication connected module (CI) is designed to transmit a data to the other processor, and receives or transmits the data in a serial type from/to a profibus having a transmitting speed of 1.5 Mbps. The physical class of the network can use RS485 standard using a token bus master.

A digital input/output module (DI/O) can provide a desired number of digital input signals or digital output signals, and has an optical isolation device.

An analog input module (AI) has an A/D converter having a desired resolution, and may receive a desired number of analog input signals per module.

The maintenance and test panel 800 is a human-mechanical unit of the digital reactor protection system to monitor the operating condition of the system and perform the periodical test and maintenance, and comprises an LCD display, a PC chassis, a CPU, a subsidiary memory unit, a printer port, a serial port, and a communication connected module (CI).

Collision problems involved in the data communication among multiple CPU processors used in one rack, are solved as follows.

That is, a driver is installed using a single board computer with Intel CPU manufactured by DY4 Inc, in order to communicate between a QNX operating system and a VMX bus. Also, when an operating system, called “V×Works”, is installed in a single board computer having a Motorola CPU, a driver for communicating between the V×Works and a VME bus is installed.

Accordingly, in the common rack using the VME bus as an internal communication bus, the Intel CPU of QNX operating system communicates with the Motorola CPU of V×Works operating system through the VME bus.

Meanwhile, in order to prevent the collision between the communication of the multiple processes and the access of the input/output unit and other unit, an arbiter is used as a controller. The communication method of a multi master system using the VME bus will be described.

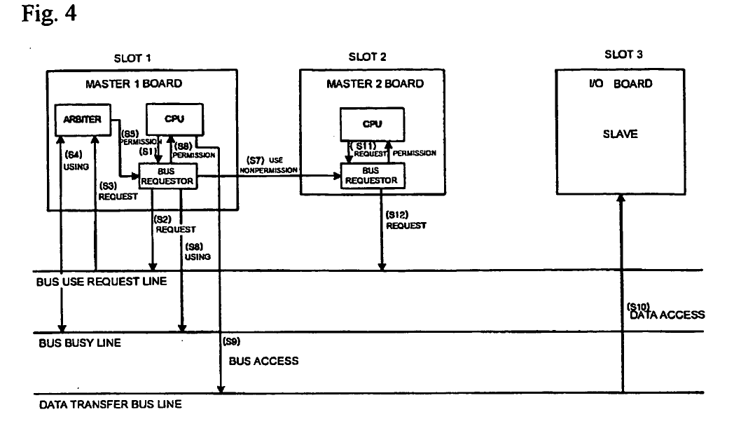

Referring to FIG. 4 illustrating the VME bus operating method of the multi master system, if the master 1 uses the external input/output unit through the VME bus from the CPU, the master 1 does not access to the input/output unit directly, but sends a bus request signal to the bus requester (step S1). The bus requestor sends a VME bus request signal to a bus use request line (step S2), and the request signal is sent to an arbiter through a bus use send line (step S3). If the bus busy signal exists (step S4), the arbiter sends a bus permission signal to the bus requestor of the master 1 (step S5). The bus requestor carries a bus busy signal on the VME bus (step S6). A bus use nonpermission signal is sent to a master 2 of a slot 2 (step S7). And then, the bus permission signal is sent to the CPU of the master 1 (step S8), and the CPU allows a gate to open toward the VME bus (step S9), so that the CPU can access to an I/O board of a slot 3, which is an external unit, using a data transfer bus line (step S10). At that time, if the CPU of the slot 2 sends the bus request signal (step S11), the bus requestor of the master 2 sends the bus request signal to the arbiter (step S12), and the arbiter transfers the bus use nonpermission signal to the bus requester of the master 2 through the bus requester of the master 1. After the master 1 of the slot 1 finishes the use of the bus, the bus nonpermission signal is changed into the bus permission signal. The problem of communication collision between the multiple processors can be solved by the above process.

C) Software Architecture

According to the present invention, programs, which are applied to processors, are sorted into those for the bistable processor and those for the coincidence logic processor, so that the sorted programs are installed in the bistable processor and coincidence logic processor, respectively. The software architecture will now be described in detail.

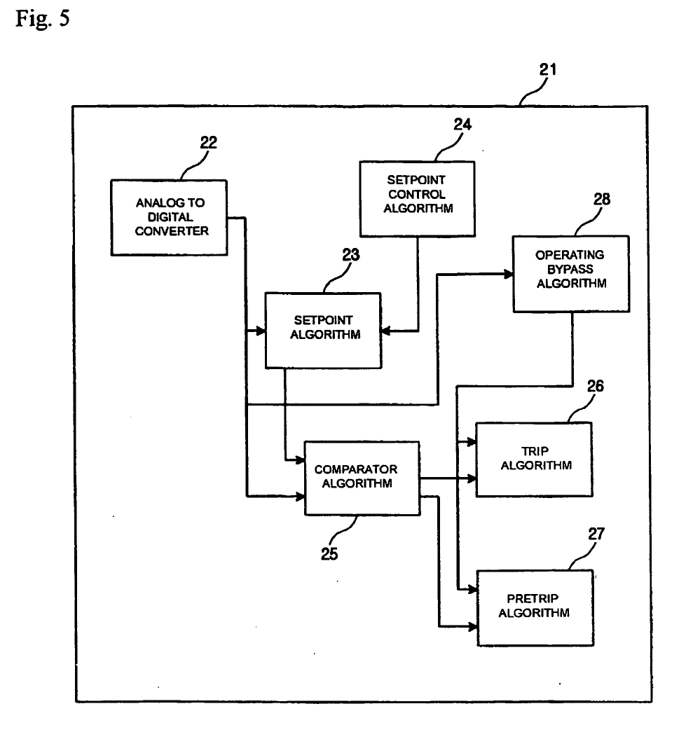

Referring to FIG. 5 illustrating the construction of the bistable software according to the present invention, the bistable software includes an analog to digital converter 22, a setpoint algorithm 23, a setpoint control algorithm 24, a comparator algorithm 25, a trip algorithm 26, a pretrip algorithm 27, and an operating bypass algorithm 28.

The analog to digital converter 22 converts a process signal of an analog type into a digital signal to transfer it to the setpoint algorithm 23 and a comparator algorithm 25.

The setpoint algorithm 23 transfers a setpoint to the comparator algorithm 25, and in case of a part of trim parameters, calculates the setpoint according to the process parameter. In the method of calculating the variable setpoint, there are a manual reset-typed variable setpoint and an automatic ratio limit-typed variable setpoint.

The automatic ratio limit-typed variable setpoint is designed in such a manner that the setpoint is automatically increased or decreased depending upon the variation of the input parameter. However, it is designed to allow an upper limit and a lower limit to have a fixed value.

The manual reset-typed variable setpoint is designed in such a manner that the setpoint is automatically decreased to a constant level by a setpoint control algorithm 24 when the operator resets by hand. However, it is designed to allow an upper limit and a lower limit to have a fixed value.

The comparator algorithm 25 serves as a major role of the bistable processor, and determines a trip and pretrip condition by comparing the setpoint algorithm signal (setpoint) with an analog/digital conversion algorithm signal (process parameter).

The trip algorithm 26 transfers the result of the comparator algorithm 25 to the bistable processor of another channel through a data communication, when the process parameter is larger than the setpoint after comparing it. If the trip signal is produced in the comparator algorithm 25, the setpoint is changed after the trip signal disappears. The trip algorithm 26 transfers the trip condition to the bistable processor, and the pretrip algorithm 27 processes the condition of the pretrip.

The operating bypass algorithm 28 has an algorithm for bypassing a specific trip function of the digital reactor protection system on starting and stopping the reactor.

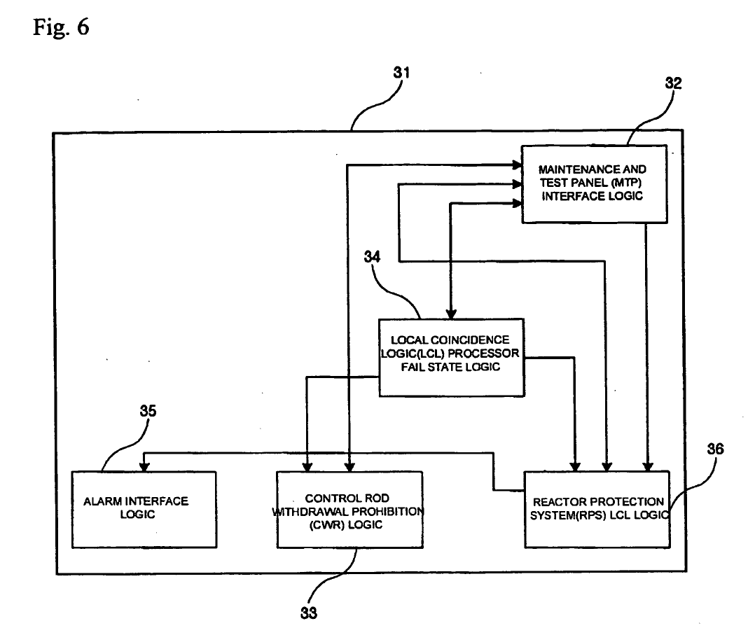

Referring to FIG. 6 illustrating the construction of the bistable software according to the present invention, the coincidence software 31 includes a maintenance and test panel (MTP) interface logic 32, a control rod withdrawal prohibition (CWR) logic 33, a local coincidence logic (LCL) processor fail state logic 34, alarm interface logic 35, and a reactor protection system (RPS) LCL logic 36.

The maintenance and test panel (MTP) interface logic 32 receives a channel bypass input inputted by the operator, and transfers it to the RPS LCL logic 36 and transfers the pretrip signal to the MTP.

The control rod withdrawal prohibition (CWR) logic 33 receives the pretrip signal from the concerned channel and other channel to execute 2of4 coincidence logic, and transfers CWP signal to a control rod control system.

The local coincidence logic (LCL) processor fail state logic 34 monitors the condition of the local coincidence logic processor, and transfers the failure condition to the local coincidence logic module 36 to cause the output of the local coincidence logic processor to be a trip condition, if the failure condition is detected.

The alarm interface logic 35 transfers the bypass of the local coincidence processor and the condition of the trip initiation to an alarm system of the power plant.

The RPS LCL logic 36 outputs a trip signal if 2of4 signal indicates the trip condition. If there is the bypass of the trip channel, the RPS LCL logic 36 outputs the trip signal if 2of3 channel indicates the trip condition.

D) Method of Developing a High-reliability Software

Generally, after the completion of the system design, the software requirement specification is prepared, and then the software is implemented based on a software design description that describes the details of functions and coding. After the preparation of the software is completed, it is built in the computer hardware, and the function and performance is confirmed through a test for each module. Thereafter, the equipment is transferred to an installed place, and a test operation is performed for a predetermined time period. If a normal operation is confirmed during the testing period, the equipment is delivered to an operator. This process is called a component design and equipment supply.

Meanwhile, the development of the safety-graded software applied to the reactor is performed considering both the contents of the system design and component design to achieve high reliability.

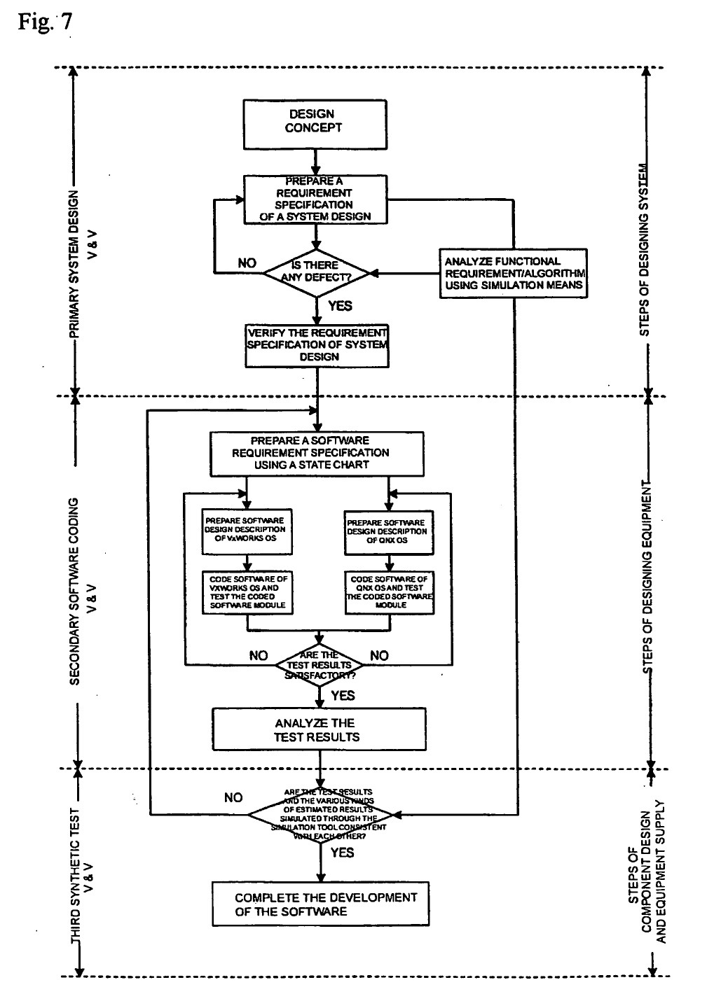

FIG. 7 is a flow chart illustrating the process of developing software of the safety grade according to the present invention.

Generally, the software errors are mostly produced at the step of preparing the software requirements specification. According to the present invention, in order to remove any design defect that may be produced during the system design, the requirements specification of system design is verified by simulating all the functions of the system design using a dynamic simulation tool and analyzing the results and characteristics of simulation. Also, in addition to the independent verification and validation, the self-design-verification is automatically performed during the design process by preparing the software requirements specification using a state chart that is a typical technique explained through a state drawing. Further, the document correction and preparation for each step can be more easily traced and managed by preparing a requirements traceability matrix using a software tool (for example, Requisite Pro).

The feature of the high-reliability software developing method according to the present invention is the self-verification and validation system performed three times at the design process.

The first verification is performed in a manner that the input/output operation of the system, the comparative logic and simultaneous logic algorithm, and the operation characteristics of the digital protection system according to the safety variables of the reactor are all realized in detail by the dynamic simulation (for example, Matlab) software at the system designing step.

The second verification at the designing step is performed at the software coding step. Specifically, the software design explanation that uses the A-type (for example, V×Works) operation system, software design explanation that uses the B-type (for example, QNX) operation system, and coding are separately prepared according to the typical software requirements specification created by the software tool. Then, after the coded software modules are tested, the testing results are compared, and if any error exists, the process returns to the software design explanation preparing step, while if no error exists, the test result analyzing step proceeds.

The third verification at the designing step is performed at the composite test step. It is confirmed whether the test results and the various kinds of estimated results simulated through the simulation tool are consistent with each other, and if they are consistent, the software development is completed. If any inconsistency exists, the process returns to the software requirements specification preparing step, and the design defect is corrected through the second verification.

Finally, though the present invention is developed as a digital reactor protection system, it can be applied to equipment that should remove a common mode failure of the digital system in the aviation, space, and medical fields that require high reliability. Also, the present invention can be applied to a safety equipment of general industries.

While this invention has been described in connection with what is presently considered to be the most practical and preferred embodiment, it is to be understood that other modifications, additions, and substitutions thereof may be made without departing from the scope of the invention. Thus, the invention should not be limited to the disclosed embodiment, but should be defined by the scope of the appended claims and their equivalents.

Industrial Applicability

As apparent from the above description, according to the digital reactor protection system that self-excludes software common mode failures according to the present invention, since the system architecture employs different kinds of CPUs and operating systems, even though common mode failures occur in a part of bistable and local coincidence logic processors, the common mode failures have no affect on other processors, so that no error occurs in the reactor protection function, thereby improving the reliability.

Accordingly, the technology of the high-reliability digital reactor protection system which is independently developed may be used in a new nuclear power plant, as well as improving the superannuated provisions of the operating nuclear power plant, thereby providing significant economic benefits.

What is claimed is:

1. A digital reactor protection system capable of self-excluding a software common mode failure comprising:
a plurality of substantially identical independent channels, wherein each channel outputs a trip signal according to a comparison result of process parameters inputted from external devices with predetermined values; and
a plurality of engineered safety features actuation systems, wherein each actuation system cools a reactor when the trip signal is inputted from one or more channels,
wherein the each channel includes,
a plurality of analog input modules, wherein each analog input module receives analog process parameters from the external devices;
a digital input module which receives digital process parameters corresponding to the analog process parameters;
two bistable process modules, wherein each bistable process module has different type of CPU, compares the analog and digital process parameters with the predetermined values corresponding to each process parameter, and outputs a trip condition signal based on the comparison results;
two coincident process modules, wherein each coincident process module has different type of operation system, is respectively connected to one of the two bistable process modules within each channel, and outputs the trip signal when at least two trip condition signals are inputted from the bistable process modules;
a reactor trip which stops a reactor; and
a initiation circuit which initiates the reactor trip and the actuation systems when the trip signal is inputted from one or more coincident process modules.

2. The digital reactor protection system of claim 1, wherein one bistable process module performs the logical comparison operation on the process parameters in a first predetermined processing order and the other bistable process module performs the logical comparison operation on the process parameters in a reverse order to the first predetermined processing order.

3. The digital reactor protection system of claim 1, wherein one coincident process module performs the logical operation on the trip condition signals in a second predetermined processing order and the other coincident process module performs the logical operation on the process parameters in a reverse order to the second predetermined processing order.

4. The digital reactor protection system of claim 1, wherein a relay contact point of a digital output of the two coincident process modules is connected with a hardwired type to form an OR circuit.

5. The digital reactor protection system of claim 1, wherein the bistable process modules and the coincidence process modules are embodied by a single board computer using VME bus.

6. A digital reactor protection method for self-excluding a software common mode failure comprising:
(a) converting analog process parameters inputted from external devices into digital process parameters;
(b) two bistable process modules in each channel comparing the digital process parameters with predetermined values corresponding to each process parameter and outputting trip condition signals if the process parameters are greater than the predetermined values corresponding to each process parameter, respectively, wherein each bistable process module has different type of CPU;
(c) two coincident process modules in each channel outputting a trip signal when at least two trip condition signals are inputted from the bistable process modules, respectively, wherein each coincident process module has different type of operation system and is respectively connected to one of the two bistable process modules within each process parameters processing channel; and
(d) initiating a reactor trip and a plurality of engineered safety features actuation systems when the trip signal inputted from one or more the coincident process modules.

7. A digital reactor protection method of claim 6, wherein the step (b) comprises:
(b1) performing the logical comparison operation on the process parameters in a first predetermined processing order; and
(b2) performing the logical comparison operation on the process parameters in a reverse order to the first predetermined processing order.

8. A digital reactor protection method of claim 6, wherein the step (c) comprises:
(c1) performing the logical operation on the trip condition signals in a second predetermined processing order; and
(c2) performing the logical operation on the trip condition signals in a reverse order to the second predetermined processing order.
